(19) United States
(12) Patent Application Publication
(10) Pub. No.: US 2022/0102855 A1
(43) Pub. Date: Mar. 31, 2022

(54) ANTENNA ASSEMBLY AND ELECTRONIC DEVICE

(71) Applicant: GUANGDONG OPPO MOBILE TELECOMMUNICATIONS CORP., LTD., Dongguan (CN)

(72) Inventor: Yuhu JIA, Dongguan (CN)

(21) Appl. No.: 17/643,415

(22) Filed: Dec. 8, 2021

Related U.S. Application Data
(63) Continuation of application No. PCT/CN2020/096544, filed on Jun. 17, 2020.

(30) Foreign Application Priority Data
Jun. 30, 2019 (CN) 201910588861.9

(51) Int. Cl. H01Q 3/30; H01Q 1/42; H01Q 1/22

(52) U.S. Cl. CPC H01Q 3/30; H01Q 1/22; H01Q 1/42

(57) ABSTRACT

An antenna assembly and an electronic device are provided. The antenna assembly includes a dielectric structure and at least one antenna module. The dielectric structure has a first region, a second region, and a third region connected sequentially in a preset direction, where the first region is configured to bring a first phase variation to a radio frequency (RF) signal, the second region is configured to bring a second phase variation to the RF signal, and the third region is configured to bring a third phase variation to the RF signal. The second phase variation is different from the first phase variation and the third phase variation. The at least one antenna module is arranged facing the dielectric structure, where a center of the at least one antenna module deviates by a preset distance relative to a center of the second region in the preset direction.

### CROSS-REFERENCE TO RELATED APPLICATION(S)

The present application is a continuation of International Application No. PCT/CN2020/096544, filed on Jun. 17, 2020, which claims priority to Chinese Patent Application Serial No. 201910588861.9, filed on Jun. 30, 2019, the entire disclosures of which are incorporated herein by reference.

### TECHNICAL FIELD

This disclosure relates to the field of electronic technology, and in particular, to an antenna assembly and an electronic device.

### BACKGROUND

With the development of mobile communication technology, people have higher and higher requirements for data transmission rate and antenna signal bandwidth, and how to improve a signal transmission quality and a data transmission rate of an antenna of an electronic device becomes a problem to be solved.

### SUMMARY

An antenna assembly and an electronic device are provided in implementations of the disclosure.

According to one aspect, an antenna assembly is provided in an implementation of the disclosure. The antenna assembly includes a dielectric structure and at least one antenna module. The dielectric structure has a first region, a second region, and a third region connected sequentially in a preset direction, where the first region is configured to bring a first phase variation to a radio frequency (RF) signal, the second region is configured to bring a second phase variation to the RF signal, and the third region is configured to bring a third phase variation to the RF signal. The second phase variation is different from the first phase variation and the third phase variation. The at least one antenna module is arranged facing the dielectric structure, where a center of the at least one antenna module deviates by a preset distance relative to a center of the second region in the preset direction, and an orthographic projection of the antenna module on the dielectric structure at least partially falls in the first region, such that a main lobe direction of a RF signal emitted by the antenna module deviates by a preset angle relative to a normal direction of the antenna module.

According to another aspect, an electronic device is provided in an implementation of the disclosure. The electronic device includes a housing, at least one resonant structure disposed at a part of the housing, and at least one millimeter-wave (mm-wave) antenna array. A center of the mm-wave antenna array deviates relative to a center of the resonant structure, and an orthographic projection of the mm-wave antenna array on the housing at least partially falls in the resonant structure. A region of the housing without the resonant structure is configured to bring a first phase variation to a mm-wave signal emitted by the mm-wave antenna array, the resonant structure and the part of the housing where the resonant structure is disposed are configured to corporately bring a second phase variation to the mm-wave signal emitted by the mm-wave antenna array, and the second phase variation is greater than the first phase variation, such that a main lobe direction of the mm-wave signal emitted by the mm-wave antenna array deviates by a preset angle relative to a normal direction of the mm-wave antenna array.

Different regions of the dielectric structure can bring different phase variations to the RF signal, such that the dielectric structure can act as a “lens”, which can converge RF signals emitted by the antenna module to concentrate energy of the RF signals, thereby increasing a gain of the antenna module. The center of the antenna module deviates relative to the center of the second region to deviate the antenna module from a central axis of the “lens”, such that the beams of the antenna module deviate from the normal direction of the antenna module after being converged at the “lens”; as such, a beam direction of the antenna module is adjustable.

### BRIEF DESCRIPTION OF THE DRAWINGS

In order to describe technical solutions of implementations more clearly, the following will give a brief introduction to the accompanying drawings used for describing implementations. Apparently, the accompanying drawings hereinafter described are merely some implementations of the disclosure. Based on these drawings, those of ordinary skill in the art can also obtain other drawings without creative effort.

FIG. 1 is a schematic structural view of an electronic device provided in implementations of the disclosure.

FIG. 2 is a schematic structural diagram illustrating a first antenna assembly provided in implementations of the disclosure.

FIG. 3 is a top view of a side where a battery cover of a first electronic device is provided in implementations of the disclosure.

FIG. 4 is a top view of a side where a battery cover of a second electronic device is provided in implementations of the disclosure.

FIG. 5 is a schematic sectional view of the electronic device illustrated in FIG. 4 along line B-B.

FIG. 6 is a schematic structural diagram illustrating a second antenna assembly provided in implementations of the disclosure.

FIG. 7 illustrates beam main lobe patterns of an antenna module provided in implementations of the disclosure, when disposed in free space and under a dielectric structure and at 28 gigahertz (GHz) and 28.5 GHz respectively.

FIG. 8 is a schematic structural diagram illustrating a third antenna assembly provided in implementations of the disclosure.

FIG. 9 is a schematic structural diagram illustrating a fourth antenna assembly provided in implementations of the disclosure.

FIG. 10 is a schematic structural diagram illustrating a fifth antenna assembly provided in implementations of the disclosure.

FIG. 11 is a first schematic sectional view of the electronic device illustrated in FIG. 3 along line A-A.

FIG. 12 is a second schematic sectional view of the electronic device illustrated in FIG. 3 along line A-A.

FIG. 13 is a third schematic sectional view of the electronic device illustrated in FIG. 3 along line A-A.

FIG. 14 is a fourth schematic sectional view of the electronic device illustrated in FIG. 3 along line A-A.

FIG. 15 is a fifth schematic sectional view of the electronic device illustrated in FIG. 3 along line A-A.

FIG. 16 is a top view of a side where a battery cover of a third electronic device is provided in implementations of the disclosure.

FIG. 17 is a schematic sectional view of the electronic device illustrated in FIG. 16 along line C-C.

FIG. 18 is a top view of a side where a battery cover of a fourth electronic device is provided in implementations of the disclosure.

FIG. 19 is a schematic sectional view of the electronic device illustrated in FIG. 18 along line D-D.

FIG. 20 is a top view of an electronic device provided in implementations of the disclosure.

FIG. 21 is a schematic cross-sectional view of the electronic device illustrated in FIG. 20 along line E-E.

FIG. 22 is a schematic cross-sectional view of the electronic device illustrated in FIG. 20 along line G-G.

### DETAILED DESCRIPTION

The technical solutions in the implementations of the present application are clearly and completely described in the following with reference to the accompanying drawings in the implementations of the present application.

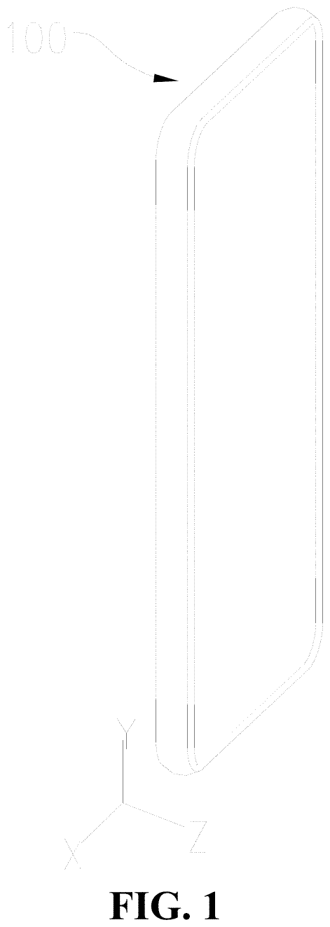

FIG. 1 is a first schematic view of an electronic device. The electronic device 100 may be any products with antennas, such as a tablet computer, a mobile phone, a notebook computer, an in-vehicle device, a wearable device, or the like. In implementations of the disclosure, the mobile phone is taken as an example of the electronic device 100. For ease of description, the electronic device 100 is defined with reference to a first viewing angle. Specifically, a width direction of the electronic device 100 is defined as an X-axis direction, a length direction of the electronic device 100 is defined as a Y-axis direction, and a thickness direction of the electronic device 100 is defined as a Z-axis direction.

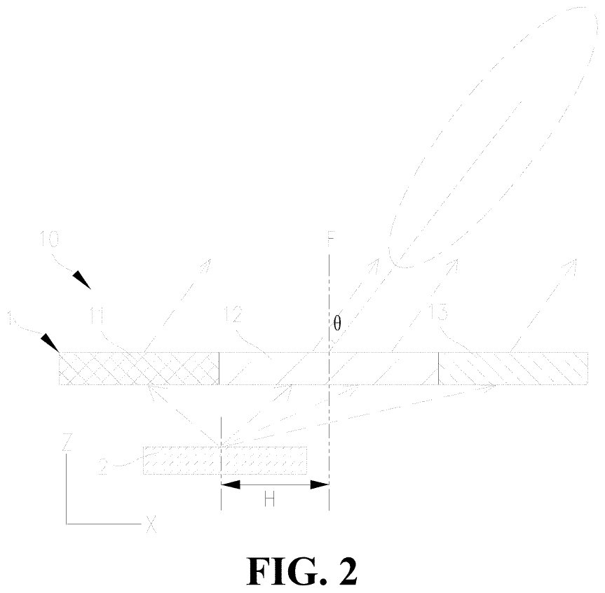

FIG. 2 illustrates an antenna assembly 10 provided in implementations of the disclosure. As illustrated in FIG. 2, the antenna assembly 10 includes a dielectric structure 1 and at least one antenna module 2. The dielectric structure 1 has a first region 11, a second region 12, and a third region 13 connected sequentially in a preset direction. The preset direction may be a length direction or a width direction of the dielectric structure 1. Alternatively, the preset direction may also be the X-axis direction, the Y-axis direction, or the Z-axis direction of the electronic device 100. The antenna module 2 is configured to receive and emit an electromagnetic wave signal. For ease of description, the electromagnetic wave signal received or emitted by the antenna module 2 is referred to as a radio frequency (RF) signal. The first region 11 is configured to bring a first phase variation to the RF signal. The second region 12 is configured to bring a second phase variation to the RF signal. The third region 13 is configured to bring a third phase variation to the RF signal. The second phase variation is different from the first phase variation and the third phase variation. The at least one antenna module 2 is arranged facing the dielectric structure 1. A center of the at least one antenna module 2 deviates by a preset distance H relative to a center of the second region 12 in the preset direction. An orthographic projection of the antenna module 2 on the dielectric structure 1 at least partially falls in the first region 11, such that a main lobe direction of a RF signal emitted by the antenna module 2 deviates by a preset angle θ from a normal direction of the antenna module 2. The antenna assembly 10 can improve antenna signal transmission quality and data transmission rate.

Different regions of the dielectric structure 1 can bring different phase variations to the RF signal, such that the dielectric structure 1 can act as a “lens”, which can converge RF signals emitted by the antenna module 2 to concentrate energy of the RF signals, thereby increasing a gain of the antenna module 2. The center of the antenna module 2 deviates relative to the center of the second region 12 to deviate the antenna module 2 from a central axis of the “lens”, such that the beams of the antenna module 2 deviate from the normal direction F of the antenna module 2 after being converged at the “lens”; as such, a beam direction of the antenna module 2 is adjustable.

The RF signal is a modulated electromagnetic wave which has a certain radiation frequency. In this implementation, the transmission frequency band of the RF signal may include, but is not limited to, millimeter-wave (mm-wave) band, submillimeter band, or terahertz band. In other implementations, the transmission frequency band of the RF signal may include medium frequency band or low frequency band. Correspondingly, the antenna module 2 can be any antenna capable of emitting electromagnetic waves of mm-wave band, submillimeter band, terahertz band, etc. The antenna module 2 includes, but is not limited to, a phased array antenna, etc. In this implementation, the mm-wave signal is taken as an example of the RF signal for illustration.

Referring to FIG. 2, the dielectric structure 1 as a whole is a substrate through which the RF signal can pass through, so that the RF signal can be radiated out through the dielectric structure 1. The first phase variation brought by the first region 11 to the RF signal represents a difference value between a phase of the RF signal before reaching the first region 11 and a phase of the RF signal after passing through the first region 11.

In a process that the RF signal passes through the dielectric structure 1, the dielectric structure 1 interacts with the RF signal, such that the RF signal has a varied phase after passing through the dielectric structure 1. The first region 11 and the second region 12 of the dielectric structure 1 have different effects on the RF signal, so that the first region 11 and the second region 12 of the dielectric structure 1 bring different phase variations to the RF signal. As such, a RF signal after passing through the first region 11 has a phase the same as or substantially the same as that of a RF signal after passing through the second region 12, so as to concentrate the energy of the RF signals and achieve beamforming of the RF signals. In this way, the gain of the antenna assembly 10 can be increased with aid of the dielectric structure 1. As an example, the third region 13 and the second region 12 of the dielectric structure 1 have different effects on the RF signal, so that the third region 13 and the second region 12 of the dielectric structure 1 can bring different phase variations to the RF signal. As such, a RF signal after passing through the third region 13 has a phase the same as or substantially the same as that of a RF signal after passing through the second region 12, so as to concentrate the energy of the RF signals and achieve beamforming of the RF signals. In this way, the gain of the antenna assembly 10 can be increased with aid of the dielectric structure 1.

In terms of the material of the dielectric structure 1, the material of the dielectric structure 1 may be uneven, so that the dielectric structure 1 can bring various phase variations to the RF signal. On the other hand, when the dielectric structure 1 is equivalent to a structure in which the first region 11 is made of an even material, the second region 12 is made of an even material, and the third region 13 is made of an even material, the first region 11, the second region 12, and the third region 13 each have a different equivalent dielectric constant. In this way, the RF signals may have different phase variations when interacting with the first region 11, the second region 12, and the third region 13 respectively. Further, it is possible to make the RF signal after passing through the first region 11 have a phase the same as or substantially the same as the RF signal after passing through the second region 12. Meanwhile, it is also possible to make the RF signal after passing through the third region 13 have a phase the same as or substantially the same as the RF signal after passing through the second region 12. Thus the energy of the RF signal can be more concentrated, and the beamforming of the RF signals can be achieved. In this way, the gain of the antenna assembly 10 can be improved with aid of the dielectric structure 1.

In terms of the equivalent refractive index of the dielectric structure 1, the dielectric structure 1 can act as a lens to concentrate the RF signals. The first region 11, the second region 12, and the third region 13 of the dielectric structure 1 each have a different equivalent refractive index to the RF signal. In this way, the RF signals may have different phase variations when interacting with the first region 11, the second region 12, and the third region 13 respectively, and it is possible to make the RF signal after passing through the first region 11 have a phase the same as or substantially the same as the RF signal after passing through the second region 12. Further, it is also possible to make the RF signal after passing through the third region 13 have a phase the same as or substantially the same as the RF signal after passing through the second region 12. Thus the energy of the RF signal can be more concentrated, and the beamforming of the RF signals can be achieved. In this way, the antenna gain can be improved with aid of the dielectric structure 1.

It can be understood that, the first region 11, the second region 12, and the third region 13 of the dielectric structure 1 can bring different phase variations to the RF signals due to reasons including, but not limited to, different characteristics of transmission materials, different secondary radiation waves generated, etc.

Referring to FIG. 2, a mobile phone is taken as an example of the electronic device 100, and the preset direction is the X-axis direction. The center of the at least one antenna module 2 deviates by the preset distance H relative to the center of the second region 12 in the preset direction. It is noted that, a specific value of the preset distance His not limited herein. For example, the preset distance H may be less than or equal to half of a length of the second region 12 in the X-axis direction. The orthographic projection of the antenna module 2 on the dielectric structure 1 at least partially falls in the first region 11, such that the main lobe direction of the RF signal emitted by the antenna module 2 deviates by the preset angle θ relative to the normal direction F of the antenna module 2. It can be understood that, the main lobe direction of the RF signal emitted by the antenna module 2 deviates by the preset angle θ relative to the normal direction F of the antenna module 2, and the preset angle θ is associated with the preset distance H.

The preset angle θ satisfies the following expression:

$$θ = {sin}^{- 1} ( \frac{\vert {φ}_{1} - {φ}_{2} \vert \times λ}{2 π \times {L}_{p a t c h}} ) ;$$

where θ represents the preset angle θ, φ₁ represents the second phase variation, φ₂ represents the first phase variation, λ represents a wavelength of the RF signal, and L_{patch} represents a length of a radiating element 21 in the preset direction.

It can be understood that, when the antenna module 2 deviates relative to the second region 12 along a positive direction of the X-axis, the main lobe direction of the RF signal emitted by the antenna module 2 deviates relative to the normal direction of the second region 12 along a negative direction of the X-axis. The greater the distance that the antenna module 2 deviates relative to the second region 12 along the positive direction of the X-axis, the greater the preset angle θ that the main lobe direction of the RF signal emitted by the antenna module 2 deviates relative to the normal direction of the antenna module 2 along the negative direction of the X-axis. In an implementation, when the orthographic projection of the antenna module 2 on the dielectric structure 1 is at least partially located on the first region 11 and the second region 12, the main lobe direction of the RF signal emitted by the antenna module 2 deviates anticlockwise by a preset angle relative to the positive direction of the X-axis. The greater the distance the center of the antenna module 2 deviates from a normal axis of symmetry of the second region 12, the greater the preset angle that the main lobe direction of the RF signal emitted by the antenna module 2 deviates from the positive direction of the X-axis in an anticlockwise direction. When the orthographic projection of the antenna module 2 on the dielectric structure 1 is at least partially located on the third region 13 and the second region 12, the main lobe direction of the RF signal emitted by the antenna module 2 deviates clockwise by a preset angle relative to the negative direction of the X-axis. The greater the distance the center of the antenna module 2 deviates from a normal axis of symmetry of the second region 12, the greater the preset angle that the main lobe direction of the RF signal emitted by the antenna module 2 deviates from the negative direction of the X-axis in a clockwise direction.

The preset distance H may be less than or equal to half of the length of the second region 12 in the X-axis direction.

In this disclosure, the manner that the second phase variation is set to be different from the first phase variation and the third phase variation includes, but is not limited to the following.

In a first possible implementation, referring to FIG. 2, the equivalent dielectric constant of the second region 12 is greater than that of the first region 11 and the third region 13, such that the second phase variation is greater than the first phase variation and the third phase variation. In other words, when the equivalent refractive index of the second region 12 is less than that of the first region 11 and the third region 13, the first region 11, the second region 12, and the third region 13 of the dielectric structure 1 is equivalent to a “lens” structure with a large thickness in the middle and a small thickness at both sides.

When the antenna module 2 is arranged facing the second region 12, a distance between the center of the antenna module 2 and the center of the second region 12 is less than a distance between the center of the antenna module 2 and the center of the first region 11, and also less than a distance between the center of the antenna module 2 and the center of the third region 13. As such, a RF signal reaching a surface of the second region 12 from the antenna module 2 has a phase less than a RF signal reaching a surface of the first region 11 or a surface of the third region 13 from the antenna module 2.

When the second phase variation is set to be greater than the first phase variation and the third phase variation, the second region 12 brings a greater phase compensation to the RF signal than the first region 11 and the third region 13, such that the RF signals have the same or substantially the same phases after passing through the first region 11, the second region 12, and the third region 13. In this way, the energy of the RF signals radiated can be more concentrated, and the beamforming of the RF signals can be achieved, such that the gain of the antenna assembly 10 can be increased after the RF signal passes through the dielectric structure 1.

Referring to FIG. 2, the equivalent dielectric constant of the first region 11 can be the same as that of the third region 13, such that the first phase variation is the same as the third phase variation. In other words, the equivalent refractive index of the first region 11 can be the same as that of the third region 13, such that the first region 11, the second region 12, and the third region 13 of the dielectric structure 1 is equivalent to a symmetrical lens structure which has a large thickness in the middle and a small thickness at both sides.

The first phase variation can be the same as the third phase variation, such that the RF signal after passing through the first region 11 and the RF signal after passing through the third region 13 can be symmetrically concentrated towards the second region 12. Furthermore, main lobes of the RF signal after passing through the first region 11 and the RF signal after passing through the third region 13 can be radiated out along or approximately along the normal direction of the second region 12. The main lobe refers to a beam with the highest radiation intensity in the RF signal.

In other implementations, the equivalent dielectric constant of the first region 11 is different from that of the third region 13, such that the first phase variation is different from the third phase variation. In this way, the dielectric structure 1 can bring a phase variation to the RF signal more flexibly, and energy concentration as well as main lobe direction adjustment of the RF signal after passing through the first region 11 and the RF signal after passing through the third region 13 can be more flexible, so as to adapt to different designs of the antenna assembly 10.

In a second possible implementation, by setting the equivalent dielectric constant of the second region 12 to be less than that of the first region 11 and the third region 13, the second phase variation is less than the first phase variation and the third phase variation. In other words, by adjusting the equivalent refractive index of the second region 12 to be greater than that of the first region 11 and the third region 13, the first region 11, the second region 12, and the third region 13 of the dielectric structure 1 is equivalent to a lens structure which has a small thickness in the middle and a large thickness at both sides.

In this implementation, the first phase variation can be the same as or different from the third phase variation, which will not be repeated herein.

The second phase variation can be less than the first phase variation and the third phase variation, such that the second region 12 brings a less phase compensation to the RF signal than the first region 11 and the third region 13. In this way, the RF signal radiated has a wider spatial coverage and a larger spatial coverage angle.

In other implementations, the dielectric structure 1 may further have a fourth region disposed at one side of the first region 11 away from the second region 12 and a fifth region disposed at one side of the third region 13 away from the second region 12. A phase variation brought by each of the fourth region and the fifth region to the RF signal is different from that brought by each of the first region 11 and the second region 12. In an implementation, a phase variation brought by the fourth region is different from that brought by the first region 11, and a phase variation brought by the fifth region is different from that brought by the third region 13. In an example, the phase variation brought by the fourth region to the RF signal is the same as the that brought by the fifth region to the RF signal, and the phase variation brought by each of the fourth region and the fifth region to the RF signal is less than that brought by the first region 11 to the RF signal, such that the dielectric structure 1 can bring gradient phase variations to the RF signal in different regions. The dielectric structure 1 in this implementation is equivalent to a lens which has a large thickness in the middle and a gradually reduced thickness at both sides, such that radiation of the RF signal emitted by the antenna module 2 is closer to the normal direction of the second region 12, which increases the gain of the antenna module 2.

Referring to FIG. 2, the second region 12 has a transmittance to the RF signal greater than the first region 11 and the third region 13.

The second region 12 is provided with a metamaterial structure. Metamaterial can be thought of as molecules and atoms of materials. The metamaterial structure consists of element structures with a size much less than a wavelength. According to the equivalent-medium theory, an artificial specific electromagnetic medium with a certain number of periodically arranged element structures as a whole can be equivalent to a homogeneous medium with certain equivalent electromagnetic parameters. The metamaterial can be an equivalent homogeneous medium with a certain thickness and has reflection and transmission coefficients. By adjusting the metamaterial structure, the reflection coefficient can be minimized and the transmission coefficient can be maximized. For example, by adjusting the metamaterial structure, the transmission coefficient of the metamaterial to the RF signal can be adjusted to be the same as or substantially the same as the transmission coefficient of air to the RF signal, so that the metamaterial has a relatively high transmittance to the RF signal.

The second region 12 is provided with the metamaterial structure, so that the second region 12 has a second transmittance to the RF signal. The first region 11 has a first transmittance to the RF signal, and the third region 13 has a third transmittance to the RF signal. Because the second region 12 is provided with the metamaterial structure, the second transmittance can be greater than the first transmittance and the third transmittance. When the antenna module 2 is arranged facing the second region 12, more RF signals emitted by the antenna module 2 can pass through the second region 12, which is possible to reduce RF signal loss of the antenna module 2 caused by the dielectric structure 1 and to improve radiation efficiency of the antenna module 2. When the antenna module 2 is applied to the electronic device 100 and the RF signal is in the mm-wave band, the application and radiation effect of the mm-wave band in the electronic device 100 such as a mobile phone can be improved.

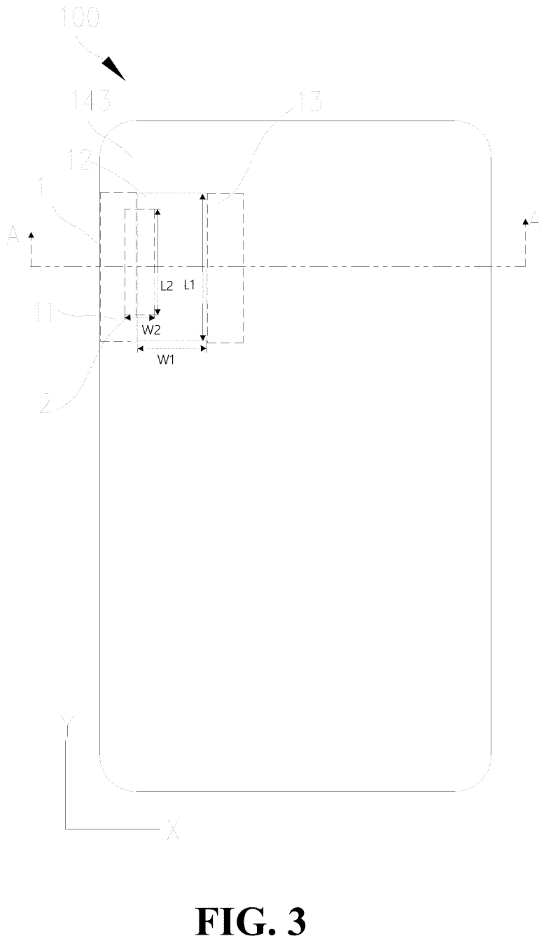

For example, referring to FIG. 3, the electronic device 100 is a mobile phone. The dielectric structure 1 is a battery cover 143 of the electronic device 100, and the antenna module 2 is disposed in the electronic device 100. The antenna module 2 can receive and emit the RF signal towards the battery cover 143 to realize communication of the electronic device 100. The RF signal can be an mm-wave signal. In this implementation, there is an improvement in the battery cover 143 of the electronic device 100, such that the battery cover 143 is partially provided with the metamaterial structure. A region of the battery cover 143 where the metamaterial structure is provided serves as the second region 12, and regions of the battery cover 143 on both sides of the metamaterial structure serve as the first region 11 and the third region 13. The metamaterial structure includes, but is not limited to, a one-dimensional, two-dimensional, or three-dimensional conductive layer structure. On the one hand, with aid of the metamaterial structure, the battery cover 143 can exhibit a high radio-wave transmission characteristic to the mm-wave signal and can act as an “mm-wave transparent battery cover 143”, which has a minimum coverage effect (blocking signal radiation) on the mm-wave antenna module 2. On the other hand, the battery cover 143 can act as local “lens” to achieve the beamforming of the mm-wave signal and increase the gain of the mm-wave antenna module 2. With the above design, it is possible to optimize application of the mm-wave band in the electronic device 100 such as a mobile phone, and improve a communication rate and a frequency band of signals of the electronic device 100.

In an example, the second region 12 is at a back surface of the electronic device 100. The second region 12 has a size of W₁ in the X-axis direction and a size of L₁ in the Y-axis direction, and the antenna module 2 has a size of W₂ in the X-axis direction and a size of L₂ in the Y-axis direction, where W₁≥W₂ and L₁≥L₂. Since the second region 12 has a relatively great transmittance to the RF signal, by setting the size of the antenna module 2 to be less than that of the second region 12, more RF signals emitted from the antenna module 2 can pass through the second region 12, such that the loss of the RF signals can be reduced, and the radiation efficiency of the antenna module 2 can be improved.

Referring to FIG. 4, when the electronic device 100 is a mobile phone and the dielectric structure 1 includes a housing substrate 14 and a metamaterial structure disposed on the housing substrate 14, the radiating element 21 in the antenna module 2 has a size of L_{patch} in the X-axis direction, where W₂>L_{patch}. In the X-axis direction, the antenna module 2 is misaligned with part of the metamaterial structure, such that the radiating element 21 has one side directly facing the housing substrate 14 and the other side directly facing the metamaterial structure, thus a main lobe direction of the RF signal emitted by the radiating element 21 deviates from a normal direction of the metamaterial structure.

Improvements to the second region 12 in the disclosure include, but are not limited to, improvements to a material of the second region 12, or provision of the metamaterial structure in the second region 12. As such, the phase variation to the RF signal brought by the second region 12 can be greater than that brought by the first region 11 and the third region 13, the gain of the antenna module 2 can be increased with aid of the dielectric structure 1, and efficient application of the antenna assembly 10 in the electronic device 100 such as a mobile phone is possible. Improvements to the second region 12 in the disclosure include, but are not limited to those provided in the implementation below.

In this implementation, the first phase variation is equal to the third phase variation, and the second phase variation is greater than the first phase variation.

Referring to FIG. 4, the antenna module 2 includes multiple radiating elements 21 arranged in a first direction, and the first direction intersects the preset direction. As an example, the first direction can be non-parallel with the preset direction. Optionally, the first direction can be perpendicular to the preset direction.

Specifically, the preset direction is the first direction, and the X-axis direction. It can be understood that, each of the multiple radiating elements 21 extends along the Y-axis direction.

In this implementation, the multiple radiating elements 21 are arranged in a linear array. In other implementations, the multiple radiating elements 21 may also be arranged in a two-dimensional matrix or a three-dimensional matrix.

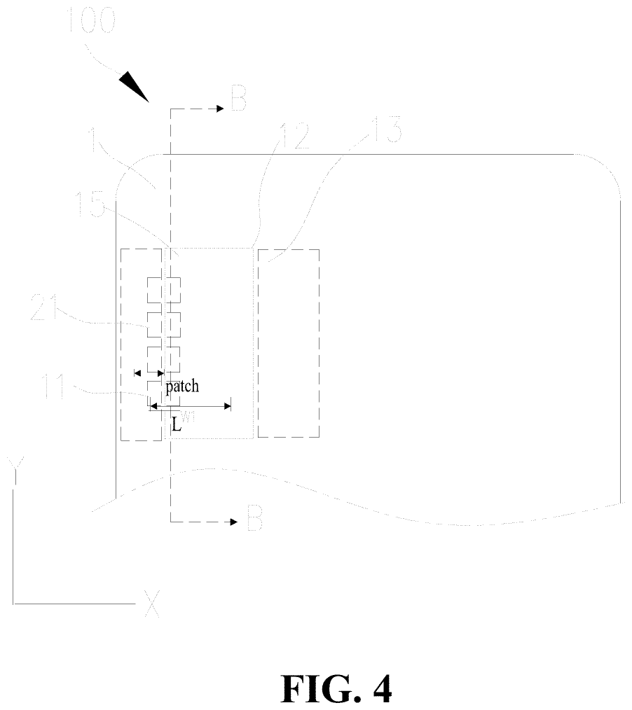

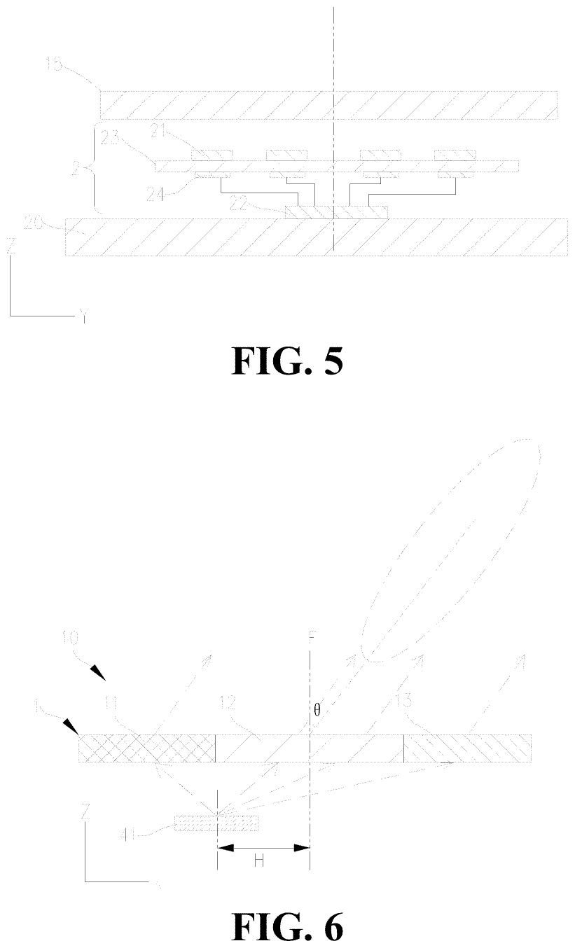

Referring to FIG. 5, the antenna module 2 further includes a RF chip 22 and an insulated substrate 23. The multiple radiating elements 21 are disposed on one side of the insulated substrate 23 facing a housing assembly. The RF chip 22 is used to generate an excitation signal (also called the RF signal). The RF chip 22 can be disposed on a main board 20 of the electronic device 100, where the RF chip 22 is at a side of the insulated substrate 23 away from the radiating element 21. The RF chip 22 is electrically connected with the multiple radiating elements 21 via transmission lines embedded in the insulated substrate 23.

Referring to FIG. 5, each radiating element 21 includes at least one feed point 24, where each feed point 24 is electrically connected with the RF chip 22 via the transmission lines. For each feed point 24, a distance between the feed point 24 and a center of the radiating element 21 corresponding to the feed point 24 is greater than the preset distance H. Input impedance of the radiating element 21 can be changed by adjusting a position of the feed point 24. In this implementation, by setting the distance between each feed point 24 and the center of the radiating element 21 corresponding to the feed point 24 to be greater than the preset distance H, the input impedance of the radiating element 21 can be changed. The input impedance of the radiating element 21 can be matched with output impedance of the RF chip 22 by adjusting the input impedance of the radiating element 21. The excitation signal generated by the RF signal has a minimum amount of reflection when the input impedance of the radiating element 21 is matched with the output impedance of the RF chip 22.

It can be understood that, the antenna module 2 may be a patch antenna. The multiple radiating elements 21 may be radiating units.

Referring to FIG. 6, the at least one antenna module 2 includes a first antenna module 41. A center of a radiating element 21 of the first antenna module 41 deviates towards the first region 11 relative to the center of the second region 12, such that a main lobe direction of a RF signal emitted by the first antenna module 41 deviates towards a side where the third region 13 is located.

Referring to FIG. 6, the greater the distance that the center of the radiating element 21 of the first antenna module 41 deviates towards the first region 11 relative to the center of the second region 12, the greater the angle that the main lobe direction of the RF signal emitted by the first antenna module 41 deviates towards the side where the third region 13 is located. Specifically, the distance that the center of the radiating element 21 of the first antenna module 41 deviates towards the first region 11 relative to the center of the second region 12 may range from zero to (W₁/2). In this case, the RF signal emitted by the first antenna module 41 will have a great gain and a less frequency deviation, and the main lobe direction of the RF signal emitted by the first antenna module 41 deviates by a relatively great angle from the normal direction of the first antenna module 41, such that the first antenna module 41 can achieve beam deflection.

The center of the radiating element 21 of the first antenna module 41 is substantially collinear with a boundary line between the first region 11 and the second region 12. In an example, the center of the radiating element 21 of the first antenna module 41 is positioned on the extension of the boundary line between the first region 11 and the second region 12.

When the distance that the center of the radiating element 21 of the first antenna module 41 deviates towards the first region 11 relative to the center of the second region 12 is (W₁/2), in the X-axis direction, the center of the radiating element 21 of the first antenna module 41 is substantially collinear with the boundary line between the first region 11 and the second region 12.

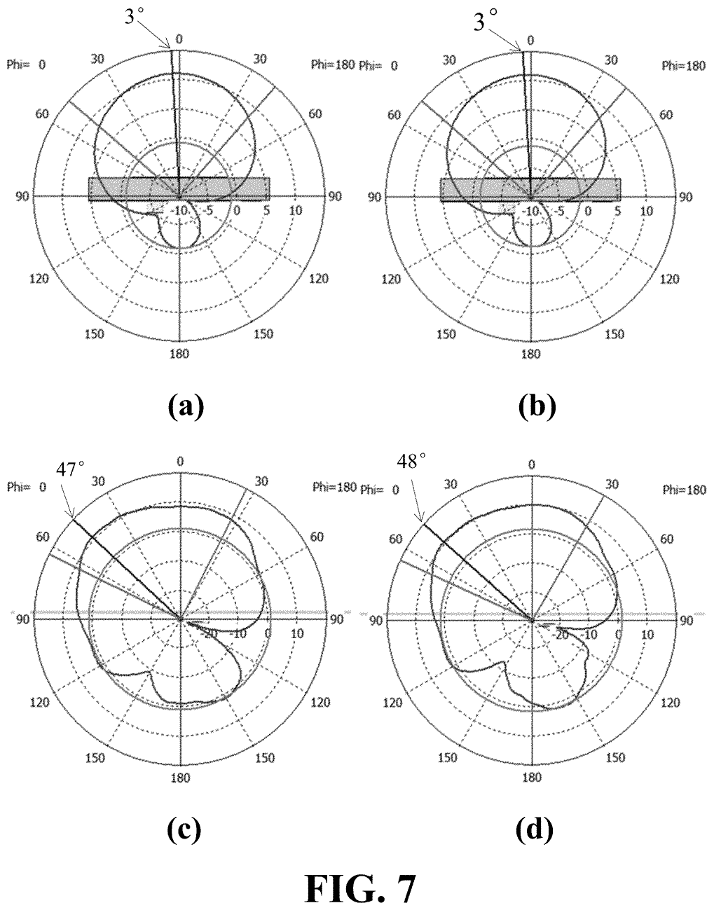

The center of the radiating element 21 of the first antenna module 41 is substantially collinear with the boundary line between the first region 11 and the second region 12, such that the main lobe direction of the RF signal emitted by the first antenna module 41 deviates by a relatively great angle towards the side where the third region 13 is located. Referring to FIG. 7a and FIG. 7b, when the antenna module 2 is operated at 28 gigahertz (GHz) in free space, the main lobe direction of the RF signal emitted by the antenna module 2 deviates by 3° relative to the normal direction of the antenna module 2. When the antenna module 2 is operated at 28.5 GHz in free space, the main lobe direction of the RF signal emitted by the antenna module 2 deviates by 3° relative to the normal direction of the antenna module 2. Referring to FIG. 7c and FIG. 7d, in the “lens” with a resonant structure 15 provided in this disclosure, the center of the radiating element 21 of the first antenna module 41 is substantially collinear with the boundary line between the first region 11 and the second region 12. As such, the main lobe direction of the RF signal of the antenna module 2 deviates by 47° from the normal direction of the antenna module 2 when the antenna module 2 is operated at 28 GHz, and the main lobe direction of the RF signal of the antenna module 2 deviates by 48° from the normal direction of the antenna module 2 when the antenna module 2 is operated at 28.5 GHz.

In other implementations, the distance that the center of the radiating element 21 of the first antenna module 41 deviates towards the first region 11 relative to the center of the second region 12 may be greater than (W₁/2), such that the first antenna module 41 can achieve beam deflection.

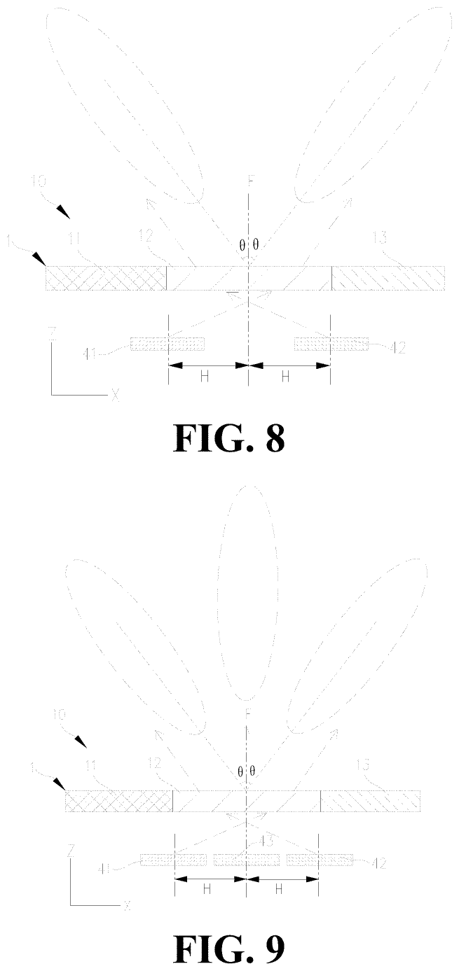

Referring to FIG. 8, the at least one antenna module 2 further includes a second antenna module 42. A center of a radiating element 21 of the second antenna module 42 deviates towards the third region 13 relative to the center of the second region 12, such that a main lobe direction of a RF signal emitted by the second antenna module 42 deviates towards a side where the first region 11 is located.

The greater the distance that the center of the radiating element 21 of the second antenna module 42 deviates towards the third region 13 relative to the center of the second region 12, the greater the angle that the main lobe direction of the RF signal emitted by the second antenna module 42 deviates towards the side where the first region 11 is located. Specifically, the distance that the center of the radiating element 21 of the second antenna module 42 deviates towards the third region 13 relative to the center of the second region 12 may range from zero to (W₁/2). In this case, the RF signal emitted by the second antenna module 42 will have a great gain and a less frequency deviation, and the main lobe direction of the RF signal emitted by the second antenna module 42 deviates by a relatively great angle from the normal direction of the second antenna module 42, such that the second antenna module 42 can achieve beam deflection.

The RF signal emitted by the first antenna module 41 deflects towards a direction opposite to the RF signal emitted by the second antenna module 42 through setting the first antenna module 41 and the second antenna module 42. In some implementations of the disclosure, the normal direction of the first region 11 is defined as 0°, the RF signal emitted by the first antenna module 41 may have a coverage ranging from 0° to 90°, and the RF signal emitted by the second antenna module 42 may have a coverage ranging from −90° to 0°. The RF signal emitted by the first antenna module 41 together with the RF signal emitted by the second antenna module 42 may have a coverage of 180°, such that a coverage of the RF signal emitted by the antenna assembly 10 can be increased and communication ability of the electronic device 100 can be improved.

Referring to FIG. 8, the center of the radiating element 21 of the second antenna module 42 is substantially collinear with a boundary line between the second region 12 and the third region 13.

The center of the radiating element 21 of the second antenna module 42 is substantially collinear with the boundary line between the second region 12 and the third region 13, such that the main lobe direction of the RF signal emitted by the second antenna module 42 deviates by a relatively great angle towards the side where the first region 11 is located. In this case, the antenna assembly 10 has a relatively good radiation performance.

Referring to FIG. 9, the at least one antenna module 2 may further include a third antenna module 43, where the third antenna module 43 is located between the first antenna module 41 and the second antenna module 42.

Specifically, main lobe directions of the RF signals emitted by the first antenna module 41, the second antenna module 42, and the third antenna module 43 are different from each other, and are staggered from one another. As such, superposition of a spatial coverage of the RF signal emitted by each of the first antenna module 41, the second antenna module 42, and the third antenna module 43 can provide a wider spatial coverage. Furthermore, the radiation performance of the antenna assembly 10 and communication ability of the electronic device 100 can be improved.

Referring to FIG. 9, a center of a radiating element 21 of the third antenna module 43 can be aligned with the center of the second region 12 in a direction perpendicular to the preset direction. In other word, the center axis of the third antenna module 43 is substantially collinear with the center axis of the second region 12.

The main lobe direction of the RF signal emitted by the third antenna module 43 is in a normal direction of the third antenna module 43 when the center of the radiating element 21 of the third antenna module 43 is aligned with the center of the second region 12 in the direction perpendicular to the preset direction. The first antenna module 41 and the second antenna module 42 deviate, relative to the main lobe of the third antenna module 43, towards opposite directions, such that the spatial coverage of each of the first antenna module 41, the second antenna module 42, and the third antenna module 43 can be superimposed to provide a relatively large spatial coverage. As such, the radiation performance of the antenna assembly 10 and communication ability of the electronic device 100 can be further improved.

In other implementations, the number of the antenna module 2 may also be greater than three, which will not be limited herein. Those skilled in the art can set the number of the antenna module 2 and the distance that the antenna module 2 deviates relative to the center of the first region 11 according to actual requirements, which are within the protection scope of the disclosure.

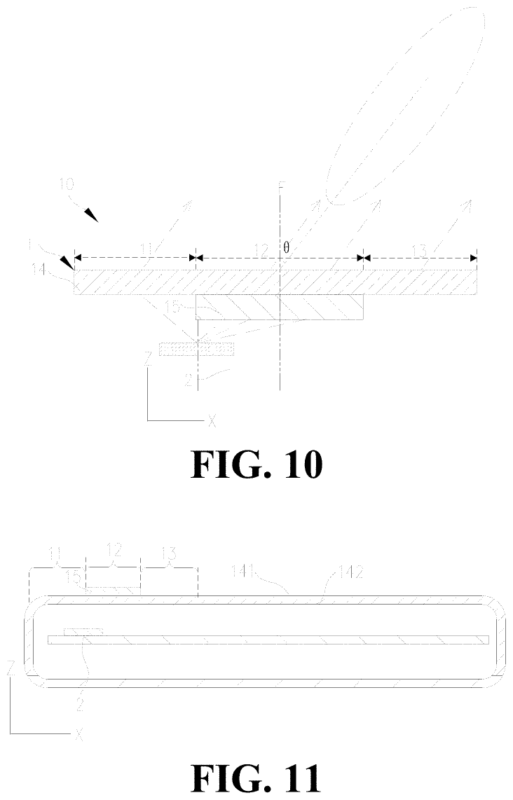

Referring to FIG. 10, the dielectric structure 1 includes a housing substrate 14 and a resonant structure 15 disposed at the housing substrate 14. A region of the housing substrate 14 where the resonant structure 15 is disposed serves as the second region 12, a region of the housing substrate 14 at one side of the resonant structure 15 serves as the first region 11, and a region of the housing substrate 14 at the other side of the resonant structure 15 serves as the third region 13. It can be understood that, the resonant structure 15 can be the above-mentioned metamaterial structure.

In one example, the electronic device 100 is a mobile phone. The dielectric structure 1 may be a battery cover 143 of the mobile phone. The resonant structure 15 can generate a secondary radiation wave under the action of the RF signal. The secondary radiation wave can interact with the input RF signal to change the phase of the RF signal, such that the second region 12 of the dielectric structure 1 can bring a relatively great phase variation to the RF signal. The housing substrate 14 is a part of a housing of the electronic device 100, and the housing substrate 14 itself can change the phase of the RF signal due to a loss caused by materials, a surface wave, etc. The phase variation brought by the housing substrate 14 to the RF signal is less than the phase variation brought by one provided with the resonant structure 15 to the RF signal.

In this implementation, by disposing the resonant structure 15 at part of the housing substrate 14, the housing substrate 14 itself brings a less phase variation to the RF signal, such that the dielectric structure 1 can be formed into a structure which can bring a less phase variation, a great phase variation, and a less phase variation in different regions of the dielectric structure 1. Such a structure is similar to a “lens” which has a large thickness in the middle and a small thickness on both sides, such that the beamforming of the RF signal of the antenna module 2 can be achieved, and the gain of the antenna module 2 can be increased. Furthermore, wider application of the mm-wave band in the electronic device 100 such as a mobile phone can be achieved.

The resonant structure 15 can be disposed at part of the housing substrate 14 in various manners which are not limited herein and can include, but are not limited to, the manners provided in the following implementations.

In a first possible implementation, referring to FIG. 11, the housing substrate 14 has a first surface 141 and a second surface 142 which is opposite to the first surface 141 and faces the antenna module 2. The resonant structure 15 is disposed on the first surface 141.

In one example, the housing substrate 14 is the battery cover 143 of the electronic device 100. The first surface 141 is an outer surface of the housing substrate 14, and the second surface 142 is an inner surface of the housing substrate 14. In an example, the resonant structure 15 may be disposed on a flexible substrate, and the flexible substrate is fixed on the first surface 141, such that the resonant structure 15 is fixed on the housing substrate 14. It can be understood that, in this implementation, the resonant structure 15 is disposed outside the housing substrate 14, and the antenna module 2 is disposed inside the electronic device 100 facing the resonant structure 15. The resonant structure 15 does not occupy space in the electronic device 100. In addition, in a case that a certain distance between the resonant structure 15 and the antenna module 2 is required, the resonant structure 15 can be disposed outside the housing substrate 14. As such, a distance between the antenna module 2 and the inner surface of the housing substrate 14 would not be too large, and the thickness of the electronic device 100 can be further reduced. It can be understood that, the surface of the resonant structure 15 can be processed to have a consistent appearance with the first surface 141.

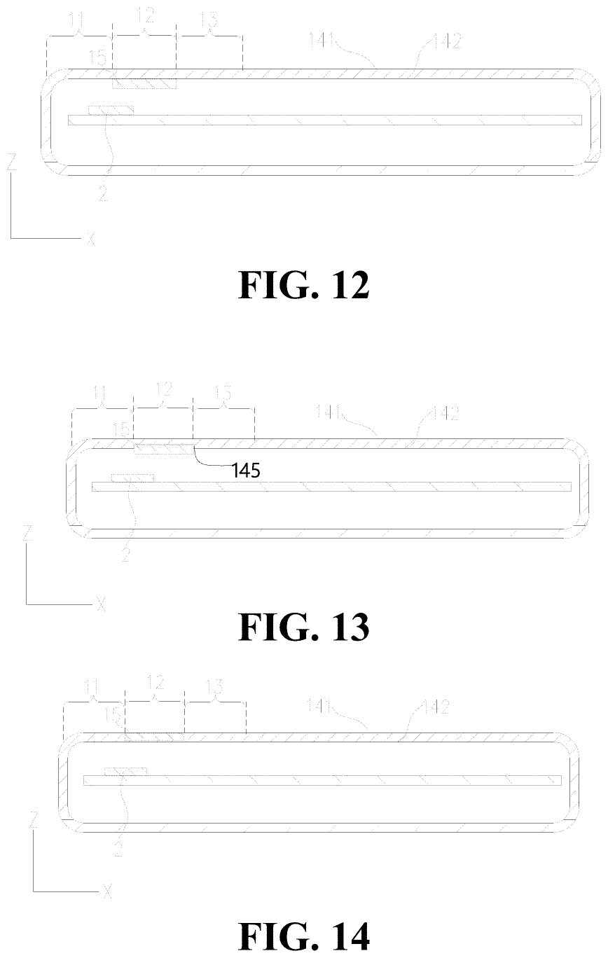

In a second possible implementation, referring to FIG. 12, the resonant structure 15 is disposed on the second surface 142, which is different from the first possible implementation.

The resonant structure 15 is disposed in the housing substrate 14 of the electronic device 100 when the resonant structure 15 is disposed on the second surface 142. As such, the resonant structure 15 is not vulnerable to wear or damage, service life of the antenna assembly 10 can be prolonged, and the appearance consistency of the housing substrate 14 can also be ensured.

In a third possible implementation, referring to FIG. 13, the resonant structure 15 is at least partially embedded between the first surface 141 and the second surface 142, which is different from the first possible implementation.

The first surface 141 or the second surface 142 can define a groove 145, and the resonant structure 15 can be disposed in the groove 145.

The resonant structure 15 is at least partially embedded between the first surface 141 and the second surface 142, such that the resonant structure 15 partially coincides with the housing substrate 14 in thickness, and the electronic device 100 can have a decreased thickness. Meanwhile, the groove 145 can provide a positioning function to the resonant structure 15, such that assembly efficiency of the antenna assembly 10 can be improved.

Referring to FIG. 14, the resonant structure 15 as a whole can be embedded between the first surface 141 and the second surface 142. The resonant structure 15 can be integrally formed with the housing substrate 14, such that the electronic device 100 can have a decreased thickness by avoiding that the resonant structure 15 is stacked with the housing substrate 14 in the Z-axis direction.

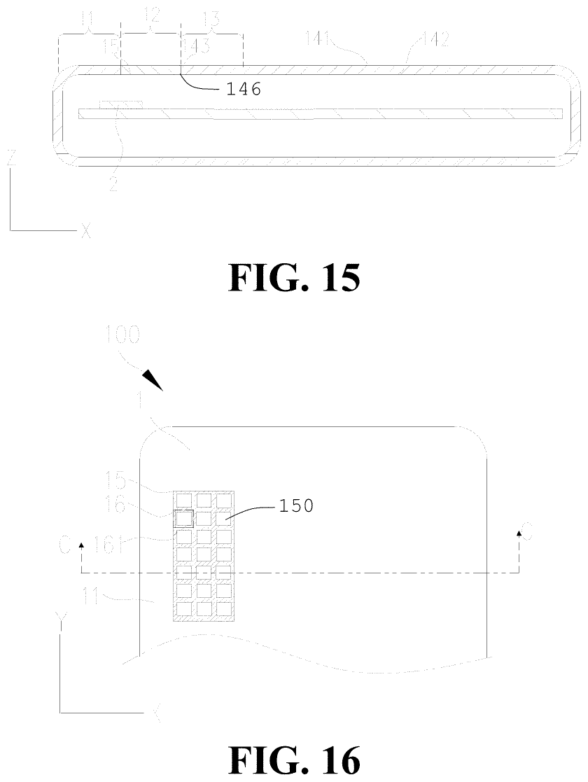

In a fourth possible implementation, referring to FIG. 15, the housing substrate 14 may define a through hole 146 extending through the first surface 141 and the second surface 142, which is different from the first possible implementation. The resonant structure 15 is received in the through hole 146, such that the electronic device 100 can have a decreased thickness by avoiding that the resonant structure 15 is stacked with the housing substrate 14 in the Z-axis direction.

Referring to FIG. 2, the antenna module 2 is spaced apart from the resonant structure 15 by a preset distance, such that the relatively strong RF signals emitted by the antenna module 2 can be sufficiently radiated to each region of the resonant structure 15, thereby improving utilization of the resonant structure 15.

Specifically, the first region 11, the second region 12, and the third region 13 are arranged along the preset direction. As a size of the resonant structure 15 in the preset direction increases, a value of the preset distance increases, such that the relatively strong RF signals emitted by the antenna module 2 can be sufficiently radiated to each region of the resonant structure 15, thereby improving utilization of the resonant structure 15.

Referring to FIG. 16, the resonant structure 15 includes multiple resonant elements 16 arranged in an array and insulated from one another. Each of the multiple the resonant elements 16 includes at least one conductive-patch layer 161.

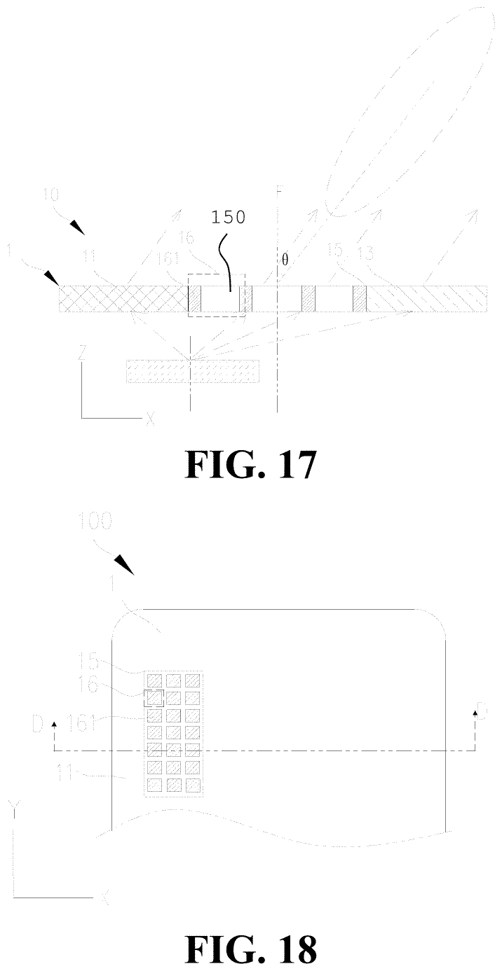

Referring to FIG. 16 and FIG. 17, the at least one conductive-patch layer 161 may be a single conductive-patch layer 161. The resonant structure 15 includes one conductive layer, where multiple through holes 150 are defined in the conductive layer and arranged at regular intervals. The through hole 150 may have various shapes including, but not limited to, cross, rectangle, rectangular ring, cross ring, circle ring, triangle, circle, polygon, etc. The through hole 150 is equivalent to a capacitor of the resonant structure 15, and a conductive part between two adjacent through holes 150 is equivalent to an inductor of the resonant structure 15. The resonant structure 15 has a fully transparent characteristic to the RF signal at a resonant frequency point, and has a reflection characteristic of different degrees to the RF signals at other frequency points. When a frequency band of the RF signal is equal to a resonant frequency band, the RF signal radiated into the resonant structure 15 can excite the resonant structure 15 to generate a secondary radiation, such that the resonant structure 15 has a relatively high transmission characteristic to the RF signal.

Additionally, the through holes 150 in the resonant structure 15 may also be arranged at irregular intervals. The through holes 150 in the resonant structure 15 may have a same shape or different shapes.

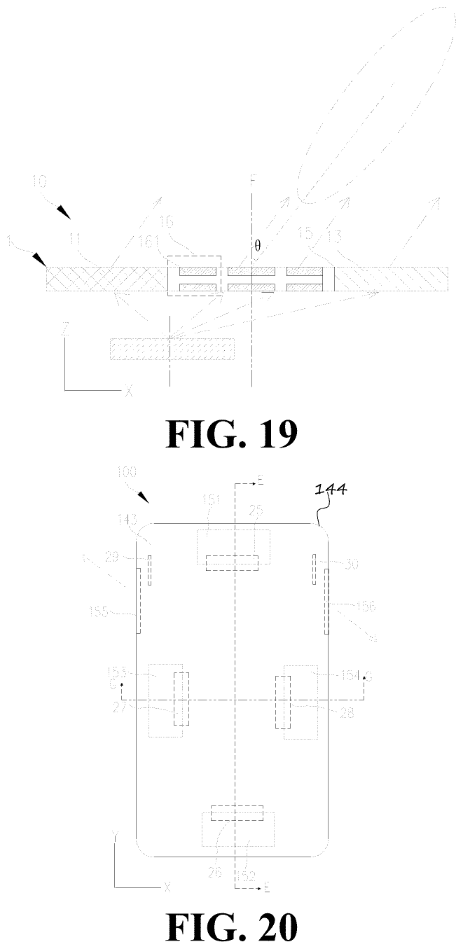

Referring to FIG. 18 and FIG. 19, the at least one conductive-patch layer 161 has multiple conductive-patch layers spaced apart, the resonant structure 15 includes multiple conductive layers spaced apart, each of the multiple conductive layers includes conductive patches 161 which are arranged in an array, and the conductive patches 161 of different conductive layers may have a same shape or different shapes. In another implementation, the resonant structure 15 includes multiple conductive layers spaced apart, where at least one of the multiple conductive layers defines through holes therein, and the through holes are arranged at regular intervals. As a non-limiting example, the resonant structure 15 includes multiple conductive layers spaced apart, where a part of the multiple conductive layers each defines through holes therein and the through holes are arranged at regular intervals, and the rest of the multiple conductive layers each includes conductive patches which are arranged in an array.

The resonant structure 15 includes multiple conductive layers spaced apart, and each of the multiple conductive layers may be a patch-type structure element or an aperture-type structure element. For example, the patch-type structure element includes multiple conductive patches 161 arranged in an array and insulated from one another. The conductive patch 161 may have various shapes including, but not limited to, cross, rectangle, rectangular ring, cross ring, circle ring, triangle, circle, polygon, etc. The conductive patch 161 is equivalent to an inductor of the resonant structure 15, and a gap between two adjacent conductive patches 161 is equivalent to a capacitor of the resonant structure 15. The conductive patch 161 has a fully reflection characteristic to the RF signal at the resonant frequency point, and has a transmission characteristic of different degrees to the RF signals at other frequency points. The resonant structure 15 may be a grid-type structure element which includes one conductive layer and through holes 150 defined in the conductive layer and arranged at regular intervals. The through hole 150 may have various shapes including, but not limited to, cross, rectangle, rectangular ring, cross ring, circle ring, triangle, circle, polygon, etc.

The conductive patches 161 of each conductive layer may have a same shape or different shapes. Adjacent conductive layers may be of a same type or different types. For example, in case of two conductive layers, the two conductive layers may adopt the patch-type structure element and the aperture-type structure element, the patch-type structure element and the patch-type structure element, the aperture-type structure element and the aperture-type structure element, or the aperture-type structure element and the patch-type structure element.

By providing a resonant structure 15 on the housing substrate 14, the reflection brought by the dielectric structure 1 to the RF signal can be reduced, and the dielectric structure 1 can have an improved transmittance to the RF signal. When the antenna assembly 10 is applied to a mobile phone, the battery cover 143 can have an improved transmittance to the RF signal. Since the resonant structure 15 is disposed at part of the housing substrate 14, the housing substrate 14 together with the resonant structure 15 can act as a lens, such that the energy of the RF signal can be concentrated and the gain of the antenna module 2 can be improved.

It can be understood that, the conductive patch 161 is made of a metal material. Of course, in other implementations, the conductive patch 161 may also be made of a non-metallic conductive material.

The housing substrate 14 may be made of at least one of plastic, glass, sapphire, or ceramic.

It can be understood that, the electronic device 100 provided in the first implementation includes the antenna assembly 10 in any of the implementations above. In case that the electronic device 100 is a mobile phone, the dielectric structure 1 of the antenna assembly 10 may be a housing which includes the housing substrate 14 and the resonant structure 15 disposed on the housing substrate 14.

In a second implementation, an electronic device 100 is further provided. The electronic device 100 in the second implementation is substantially identical to the electronic device 100 provided in the first implementation except the following. The electronic device 100 includes a housing, at least one resonant structure 15 disposed at part of the housing, and at least one mm-wave antenna array. A center of the mm-wave antenna array deviates relative to a center of the resonant structure 15. An orthographic projection of the mm-wave antenna array on the housing at least partially falls in the resonant structure 15. A region of the housing without the resonant structure 15 and the part of the housing where the resonant structure 15 is disposed are configured to corporately bring a first phase variation to a mm-wave signal emitted by the mm-wave antenna array, the resonant structure 15 is configured to bring a second phase variation to the mm-wave signal emitted by the mm-wave antenna array, and the second phase variation is greater than the first phase variation, such that a main lobe direction of the mm-wave signal emitted by the mm-wave antenna array deviates by a preset angle θ from a normal direction of the mm-wave antenna array.

As for the housing, reference can be made to the above description of the housing substrate 14 in the first implementation. As for the resonant structure 15, reference can be made to the above description in the first implementation. As for the mm-wave antenna array, reference can be made to the above description of the antenna module 2 in the first implementation, which will not be repeated herein.

In this implementation, a mobile phone is taken as an example of the electronic device 100 for illustration. The housing is the battery cover 143. The electronic device 100 is a mobile phone at least capable of the mm-wave communication.

When the resonant structure 15 is disposed at part of the housing, the phase variation brought by the resonant structure 15 to the RF signal is different from the phase variations brought by other regions of the housing to the RF signal. As such, the housing can act as a “lens”, which can converge the RF signals emitted by the mm-wave antenna array to concentrate energy of the RF signals, thereby increasing the gain of the mm-wave antenna array. The center of the mm-wave antenna array deviates relative to the center of the second region 12 to deviate the mm-wave antenna array from a central axis of the “lens”. As such, the beams of the mm-wave antenna array deviate from the normal direction of the mm-wave antenna array after being converged at the “lens”, as such, a beam direction of the mm-wave antenna array is adjustable.

In an implementation, referring to FIG. 19 and FIG. 20, the at least one resonant structure 15 can include a first resonant structure 151 and a second resonant structure 152 spaced apart from the first resonant structure 151. The at least one mm-wave antenna array can include a first mm-wave antenna array 25 and a second mm-wave antenna array 26. The first mm-wave antenna array 25 corresponds to the first resonant structure 151. That is, an orthographic projection of the first mm-wave antenna array 25 on the battery cover 143 at least partially overlaps with that of the first resonant structure 151 on the battery cover 143. The second mm-wave antenna array 26 corresponds to the second resonant structure 152. That is, an orthographic projection of the second mm-wave antenna array 26 on the battery cover 143 at least partially overlaps with that of the second resonant structure 152 on the battery cover 143. A deviation direction of the first mm-wave antenna array 25 relative to the first resonant structure 151 is opposite to a deviation direction of the second mm-wave antenna array 26 relative to the second resonant structure 152.

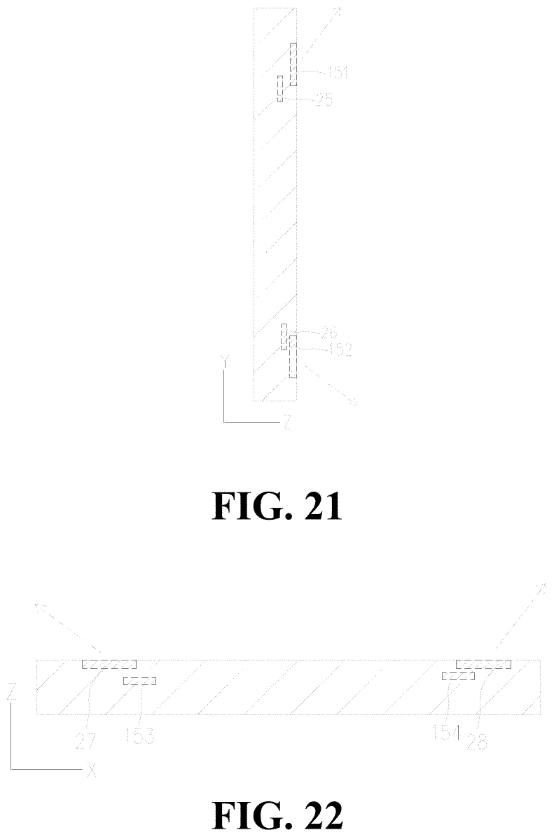

Referring to FIG. 20 and FIG. 21, the mm-wave antenna array arranged in a linear array is taken as an example for illustration. The first mm-wave antenna array 25 and the second mm-wave antenna array 26 can extend along the X-axis direction. In this case, the first mm-wave antenna array 25 and the second mm-wave antenna array 26 can perform beam scanning along the X-axis direction. Accordingly, the first resonant structure 151 and the second resonant structure 152 are disposed facing each other and extend along the X-axis direction. As an example, the first resonant structure 151 is close to a top of the housing, and the second resonant structure 152 is close to a bottom of the housing (as illustrated in FIG. 20). The first mm-wave antenna array 25 deviates, towards the second resonant structure 152, relative to the first resonant structure 151. The second mm-wave antenna array 26 deviates, towards the first resonant structure 151, relative to the second resonant structure 152. As such, a main lobe direction of a RF signal emitted by the first mm-wave antenna array 25 is obliquely upward relative to the electronic device 100 (as illustrated in FIG. 20), and a main lobe direction of a RF signal emitted by the second mm-wave antenna array 26 is obliquely downward relative to the electronic device 100 (as illustrated in FIG. 21). Furthermore, the first mm-wave antenna array 25 and the second mm-wave antenna array 26 can be combined to provide a relatively large signal coverage, thereby improving the mm-wave communication quality of the electronic device 100.

In other implementations, a pair of mm-wave antenna arrays can be set to extend along the Y-axis direction, and main lobes of the pair of mm-wave antenna arrays can be set to deviate towards opposite directions.

Referring to FIG. 20 and FIG. 22, the at least one resonant structure 15 further includes a third resonant structure 153. The at least one mm-wave antenna array further includes a third mm-wave antenna array 27. The third mm-wave antenna array 27 corresponds to the third resonant structure 153. That is, an orthographic projection of the third mm-wave antenna array 27 on the battery cover 143 at least partially overlaps with that of the third resonant structure 153 on the battery cover 143. An arrangement direction of radiating elements 21 in the third mm-wave antenna array 27 intersects an arrangement direction of radiating elements 21 in the second mm-wave antenna array 26. As an example, a projection of the third mm-wave antenna array 27 on the battery cover 143 at least partially overlaps with a projection of the third resonant structure 153 on the battery cover 143, and the arrangement direction of the radiating elements 21 in the third mm-wave antenna array 27 is non-parallel with the arrangement direction of the radiating elements 21 in the second mm-wave antenna array 26. Optionally, the arrangement direction of the radiating elements 21 in the third mm-wave antenna array 27 is perpendicular to the arrangement direction of the radiating elements 21 in the second mm-wave antenna array 26.

The radiating elements 21 in the second mm-wave antenna array 26 are arranged along the X-axis direction, the second mm-wave antenna array 26 performs beam scanning along the X-axis direction, and the second mm-wave antenna array 26 can have an increased gain along the X-axis direction. The radiating elements 21 in the third mm-wave antenna array 27 are arranged along the Y-axis direction, the third mm-wave antenna array 27 perform beam scanning along the Y-axis direction, and the third mm-wave antenna array 27 can have an increased gain along the Y-axis direction. As such, the third mm-wave antenna array 27 and the second mm-wave antenna array 26 can perform high-gain beam-scanning respectively along different directions, thereby improving spatial beam coverage and the gain of the electronic device 100.

Referring to FIG. 20 and FIG. 22, the at least one resonant structure 15 further includes a fourth resonant structure 154. The at least one mm-wave antenna array further includes a fourth mm-wave antenna array 28. The fourth mm-wave antenna array 28 corresponds to the fourth resonant structure 154. That is, an orthographic projection of the fourth mm-wave antenna array 28 on the battery cover 143 at least partially overlaps with that of the fourth resonant structure 154 on the battery cover 143. Radiating elements 21 in the fourth mm-wave antenna array 28 are arranged along the Y-axis direction. A deviation direction of the third mm-wave antenna array 27 relative to the third resonant structure 153 is opposite to a deviation direction of the fourth mm-wave antenna array 28 relative to the fourth resonant structure 154.

The third mm-wave antenna array 27 and the fourth mm-wave antenna array 28 can perform beam scanning along the Y-axis direction, and the third mm-wave antenna array 27 and the fourth mm-wave antenna array 28 each can have an increased gain along the Y-axis direction.

As an example, the housing includes the battery cover 143. The first mm-wave antenna array 25, the second mm-wave antenna array 26, and the third mm-wave antenna array 27 each are disposed on the battery cover 143.

With combinations of the first, second, third, and fourth mm-wave antenna arrays, the electronic device 100 provided in this implementation can perform high-gain beam-scanning along a vertical direction and a horizontal direction at a back surface of the electronic device 100. The antenna arrays can emit beams towards various sides of the back surface of the electronic device 100 such as an oblique upward side, an oblique downward side, an oblique leftward side, an oblique rightward side, etc. (with reference to FIG. 21 and FIG. 22), thereby improving the spatial beam coverage and the gain of the electronic device 100.

Referring to FIG. 20, the housing further includes a middle frame 144 surrounding a periphery of the battery cover 143. The at least one resonant structure 15 further includes a fifth resonant structure 155 and a sixth resonant structure 156. The fifth resonant structure 155 and the sixth resonant structure 156 are oppositely disposed on the middle frame 144. The at least one mm-wave antenna array further includes a fifth mm-wave antenna array 29 and a sixth mm-wave antenna array 30. The fifth mm-wave antenna array 29 corresponds to the fifth resonant structure 155, and the sixth mm-wave antenna array 30 corresponds to the sixth resonant structure 156. The radiating elements 21 in the fifth mm-wave antenna array 29 are arranged along a direction which is the same as an extending direction of a side of the middle frame 144 where the fifth resonant structure 155 is located. A deviation direction of the fifth mm-wave antenna array relative to the fifth resonant structure 155 is opposite to a deviation direction of the sixth mm-wave antenna array relative to the sixth resonant structure 156.

With combinations of the first, second, third, fourth, fifth, and sixth mm-wave antenna arrays, the electronic device 100 provided in this implementation can perform high-gain beam-scanning along the vertical direction and the horizontal direction of the electronic device 100. The antenna arrays can emit beams towards various sides of the back surface of the electronic device 100 such as an oblique upward side, an oblique downward side, an oblique leftward side, an oblique rightward side, a upper left side, a lower left side, etc. (with reference to FIG. 20), thereby improving the spatial beam coverage and the gain of the electronic device 100.

In this disclosure, the number of the antenna array includes, but is not limited to the number provided in the above implementations, and arrangement manners of the three antenna arrays include, but are not limited to the manners provided in the above implementations.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An antenna assembly, comprising:
a dielectric structure having a first region, a second region, and a third region connected sequentially in a preset direction, wherein the first region is configured to bring a first phase variation to a radio frequency (RF) signal, the second region is configured to bring a second phase variation to the RF signal, and the third region is configured to bring a third phase variation to the RF signal, and wherein the second phase variation is different from the first phase variation and the third phase variation; and
at least one antenna module arranged facing the dielectric structure, wherein a center of the at least one antenna module deviates by a preset distance relative to a center of the second region in the preset direction, and wherein an orthographic projection of the antenna module on the dielectric structure at least partially falls in the first region, such that a main lobe direction of a RF signal emitted by the antenna module deviates by a preset angle relative to a normal direction of the antenna module.

2. The antenna assembly of claim 1, wherein the first phase variation is equal to the third phase variation, and the second phase variation is greater than the first phase variation.

3. The antenna assembly of claim 2, wherein the antenna module comprises a plurality of radiating elements arranged in a first direction, and the first direction is non-parallel with the preset direction.

4. The antenna assembly of claim 3, wherein the at least one antenna module comprises a first antenna module, a center of a radiating element of the first antenna module deviating towards the first region relative to the center of the second region, such that a main lobe direction of a RF signal emitted by the first antenna module deviates towards a side where the third region is located.

5. The antenna assembly of claim 4, wherein the center of the radiating element of the first antenna module is substantially collinear with a boundary line between the first region and the second region.

6. The antenna assembly of claim 4, wherein the at least one antenna module further comprises a second antenna module, a center of a radiating element of the second antenna module deviating towards the third region relative to the center of the second region, such that a main lobe direction of a RF signal emitted by the second antenna module deviates towards a side where the first region is located.

7. The antenna assembly of claim 6, wherein the center of the radiating element of the second antenna module is substantially collinear with a boundary line between the second region and the third region.

8. The antenna assembly of claim 6, wherein the at least one antenna module further comprises a third antenna module, and the third antenna module is located between the first antenna module and the second antenna module.

9. The antenna assembly of claim 8, wherein a center of a radiating element of the third antenna module is aligned with the center of the second region in a direction perpendicular to the preset direction.

10. The antenna assembly of claim 3, wherein the preset angle satisfies the following expression:
$$θ = {sin}^{- 1} ( \frac{\vert {φ}_{1} - {φ}_{2} \vert \times λ}{2 π \times {L}_{p a t c h}} ) ;$$
wherein θ represents the preset angle, φ₁ represents the second phase variation, φ₂ represents the first phase variation, λ represents a wavelength of the RF signal, and L_{patch} represents a length of the radiating element in the preset direction.

11. The antenna assembly of claim 1, wherein the second region has a transmittance to the RF signal greater than the first region and the third region.

12. The antenna assembly of claim 1, wherein:
the dielectric structure comprises a housing substrate and a resonant structure disposed at the housing substrate; and
a region of the housing substrate where the resonant structure is disposed serves as the second region, a region of the housing substrate at one side of the resonant structure serves as the first region, and a region of the housing substrate at another side of the resonant structure serves as the third region.

13. The antenna assembly of claim 12, wherein the housing substrate has a first surface and a second surface which is opposite to the first surface and faces the antenna module; and
wherein:
the resonant structure is disposed on the first surface; or
the resonant structure is disposed on the second surface; or
the resonant structure is at least partially embedded between the first surface and the second surface.

14. The antenna assembly of claim 12, wherein the resonant structure comprises one conductive layer, wherein a plurality of through holes are defined in the conductive layer and arranged at regular intervals.

15. The antenna assembly of claim 12, wherein the resonant structure comprises a plurality of conductive layers spaced apart, each of the plurality of conductive layers comprises conductive patches which are arranged in an array, and the conductive patches of different conductive layers have a same shape or different shapes.

16. The antenna assembly of claim 12, wherein the resonant structure comprises a plurality of conductive layers spaced apart; at least one of the plurality of conductive layers defines through holes therein, and the through holes are arranged at regular intervals.

17. An electronic device comprising an antenna assembly and a main board, wherein:
the antenna assembly comprises a dielectric structure and at least one antenna module, wherein:
the dielectric structure has a first region, a second region, and a third region connected sequentially in a preset direction, wherein the first region is configured to bring a first phase variation to a radio frequency (RF) signal, the second region is configured to bring a second phase variation to the RF signal, and the third region is configured to bring a third phase variation to the RF signal, and wherein the second phase variation is different from the first phase variation and the third phase variation; and
at least one antenna module is arranged facing the dielectric structure, wherein a center of the at least one antenna module deviates by a preset distance relative to a center of the second region in the preset direction, and wherein an orthographic projection of the antenna module on the dielectric structure at least partially falls in the first region, such that a main lobe direction of a RF signal emitted by the antenna module deviates by a preset angle relative to a normal direction of the antenna module; and
the antenna module further comprises a RF chip, wherein the RF chip is disposed on the main board.

18. An electronic device, comprising:
a housing;
at least one resonant structure disposed at a part of the housing; and
at least one millimeter-wave (mm-wave) antenna array, wherein:
a center of the mm-wave antenna array deviates relative to a center of the resonant structure, and an orthographic projection of the mm-wave antenna array on the housing at least partially falls in the resonant structure; and
a region of the housing without the resonant structure is configured to bring a first phase variation to a mm-wave signal emitted by the mm-wave antenna array, the resonant structure and the part of the housing where the resonant structure is disposed are configured to corporately bring a second phase variation to the mm-wave signal emitted by the mm-wave antenna array, and the second phase variation is greater than the first phase variation, such that a main lobe direction of the mm-wave signal emitted by the mm-wave antenna array deviates by a preset angle relative to a normal direction of the mm-wave antenna array.

19. The electronic device of claim 18, wherein the at least one resonant structure comprises a first resonant structure and a second resonant structure spaced apart from the first resonant structure, the at least one mm-wave antenna array comprises a first mm-wave antenna array and a second mm-wave antenna array, the first mm-wave antenna array corresponds to the first resonant structure, the second mm-wave antenna array corresponds to the second resonant structure, and a deviation direction of the first mm-wave antenna array relative to the first resonant structure is opposite to a deviation direction of the second mm-wave antenna array relative to the second resonant structure.

20. The electronic device of claim 19, wherein the at least one resonant structure further comprises a third resonant structure, the at least one mm-wave antenna array further comprises a third mm-wave antenna array, the third mm-wave antenna array corresponds to the third resonant structure, and an arrangement direction of radiating elements in the third mm-wave antenna array is non-parallel with an arrangement direction of radiating elements in the second mm-wave antenna array.
